(19) United States
(12) Patent Application Publication
(10) Pub. No.: US 2008/0001425 A1
(43) Pub. Date: Jan. 3, 2008

(54) Vehicle seat assembly

(75) Inventor: Tiago Castro, Royal Oak, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/476,943

(22) Filed: Jun. 29, 2006

(51) Int. Cl. B60N 2/22

(52) U.S. Cl. 296/65.16

(57) ABSTRACT

A vehicle seat assembly includes a seat support structure, a seat back portion coupled to the seat support structure and a seat cushion portion coupled to the seat support structure. The seat cushion portion includes a rear section and a front section. The front section is movably mounted to the seat support structure for operation in a passenger supporting orientation and an upright cargo retaining orientation.

### BACKGROUND OF THE INVENTION

1. Field of the Invention

The present invention generally relates to a vehicle seat assembly. More specifically, the present invention relates to vehicle seat assembly with cargo retaining features.

2. Background Information

Vehicles are continually being redesigned and improved for functionality. One area of continuing redesign concerns the use of spaces within the vehicle for carrying cargo and/or luggage. Further, many vehicles now include features that restrict movement of cargo within the vehicle during rapid changes in acceleration. For example, many station wagon type vehicles include a cargo net within the vehicle to confine cargo or luggage to a predetermined space at the rear of the vehicle. Similarly, many truck spaces are equipped with a net or similar feature for restricting movement of cargo or luggage.

Recently, some vehicles have been provided with features that restrict the movement of cargo or luggage that has been placed on a passenger seat within the passenger compartment of the vehicle. For example, one vehicle passenger seat design includes a panel installed on a generally vertical front surface of a passenger seat that slide up and down along a pair of tracks between a lowered retracted position and an extended position. In the extended position, a portion of the panel protrudes above an upper surface of the passenger seat creating a wall that restricts forward movement of cargo or luggage upon sudden braking. Unfortunately such sliding panels are unsightly and are limited in utility.

In view of the above, it will be apparent to those skilled in the art from this disclosure that there exists a need for an improved passenger seat cargo retaining design that has improved functionality and more appealing appearance. This invention addresses this need in the art as well as other needs, which will become apparent to those skilled in the art from this disclosure.

### SUMMARY OF THE INVENTION

On object of the present invention is to prevent items placed on the passenger seat cushion from sliding off the seat onto the floor of the vehicle during sudden changes in acceleration and/or speed changes, for instance, as a result of sudden heavy braking.

Another object of the invention is to provide a vehicle seat assembly that provides for storage underneath the seat cushion.

In accordance with one aspect of the present invention, a vehicle seat assembly includes a seat support structure, a seat back portion coupled to the seat support structure and a seat cushion portion coupled to the seat support structure. The seat cushion portion includes a rear section and a front section. The front section is movably mounted to the seat support structure for operation in a passenger supporting orientation and an upright cargo retaining orientation.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a side elevational view of a vehicle that includes a vehicle seat assembly in accordance with the present invention;

FIG. 2 is a perspective view of the vehicle seat assembly shown removed from the vehicle in accordance with a first embodiment of the present invention;

FIG. 3 is a side elevation of the vehicle seat assembly showing a front seat cushion portion in an upright cargo retaining orientation which restricts movement of a parcel in accordance with the first embodiment of the present invention;

FIG. 4 is another side elevational view of the vehicle seat assembly showing the front seat cushion portion in the upright cargo retaining orientation restricting forward movement of the parcel in accordance with the first embodiment of the present invention;

FIG. 5 is an exploded perspective view of the vehicle seat assembly that showing a rear seat cushion portion and the front seat cushion portion, the front seat cushion portion being pivotal between a passenger supporting orientation and the upright cargo retaining orientation in accordance with the first embodiment of the present invention;

FIG. 6 is a side cross-sectional view of a lower area of the vehicle seat assembly taken along the line 6-6 in FIG. 2 showing details of one of two hinges that support pivotal movement of the front seat cushion portion, with the front seat portion in the passenger supporting orientation in accordance with the first embodiment of the present invention;

FIG. 7 is another side cross-sectional view of the lower area of the vehicle seat assembly similar to FIG. 6 showing the hinge with the front seat portion in the upright cargo retaining orientation in accordance with the first embodiment of the present invention;

FIG. 8 is a side cross-sectional view of the vehicle seat assembly taken along the line 8-8 in FIG. 2 showing the front seat cushion portion in the passenger supporting orientation in accordance with the first embodiment of the present invention;

FIG. 9 is a side cross-sectional view of the vehicle seat assembly similar to FIG. 8 showing the front seat cushion portion in the upright cargo retaining orientation in accordance with the first embodiment of the present invention;

FIG. 10 is a side cross-sectional view of the vehicle seat assembly similar to FIG. 6 showing one of two hinges that support pivotal movement of the front seat cushion portion, with the front seat portion in the passenger supporting orientation in accordance with a second embodiment of the present invention;

FIG. 11 is another side cross-sectional view of the vehicle seat assembly similar to FIG. 10 showing the hinge with the front seat portion in the upright cargo retaining orientation in accordance with the second embodiment of the present invention;

FIG. 12 is a side cross-sectional view of the vehicle seat assembly showing a front seat cushion portion in the passenger supporting orientation in accordance with a second embodiment of the present invention; and

FIG. 13 is a side cross-sectional view of the vehicle seat assembly showing the front seat cushion portion in the upright cargo retaining orientation in accordance with the second embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

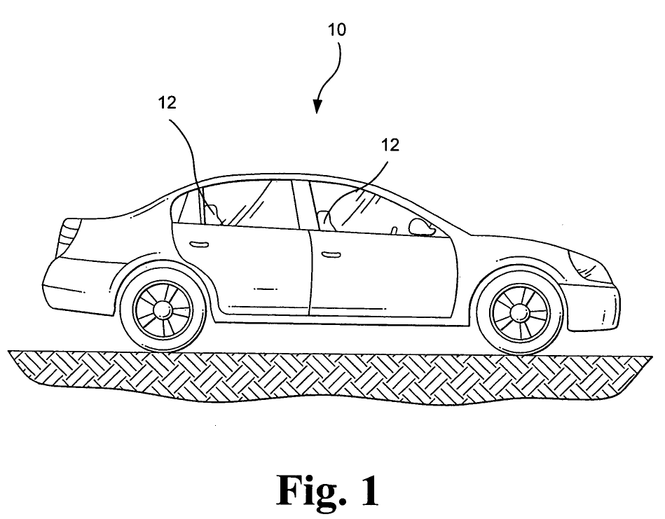

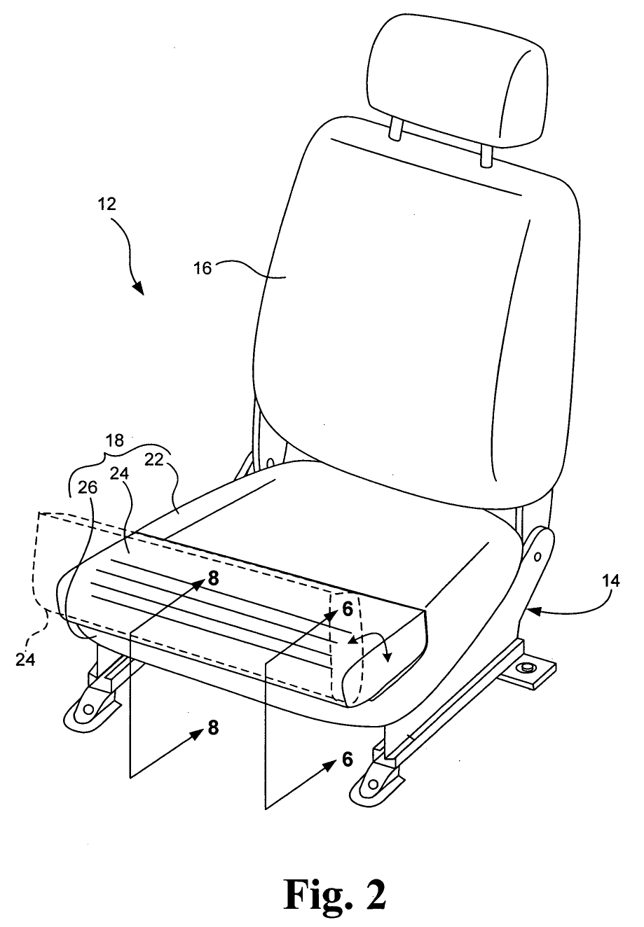

Referring initially to FIG. 1, a vehicle 10 is illustrated that includes one or more vehicle seat assemblies 12 in accordance with a first embodiment of the present invention. As more particularly shown in FIG. 2, the vehicle seat assembly 12 basically includes a seat support structure 14, a seat back portion 16 coupled to the seat support structure 14 and a seat cushion portion 18 that is also coupled to the seat support structure 14. The vehicle seat assembly 12 includes other various seat elements that will not discussed or illustrated in detail herein, since they are conventional components that are well known in the art. The seat cushion portion 18 basically includes a rear section 22, a front section 24 and a front support section 26. The front section 24 is movably mounted on the front support section 26 for movement between a passenger supporting orientation (solid lines in FIG. 2) and an upright cargo retaining orientation (dashed lined in FIG. 2). In the illustrated embodiment, the front support section 26 is integrated with the front end of the rear section 22 and supports the front section 24.

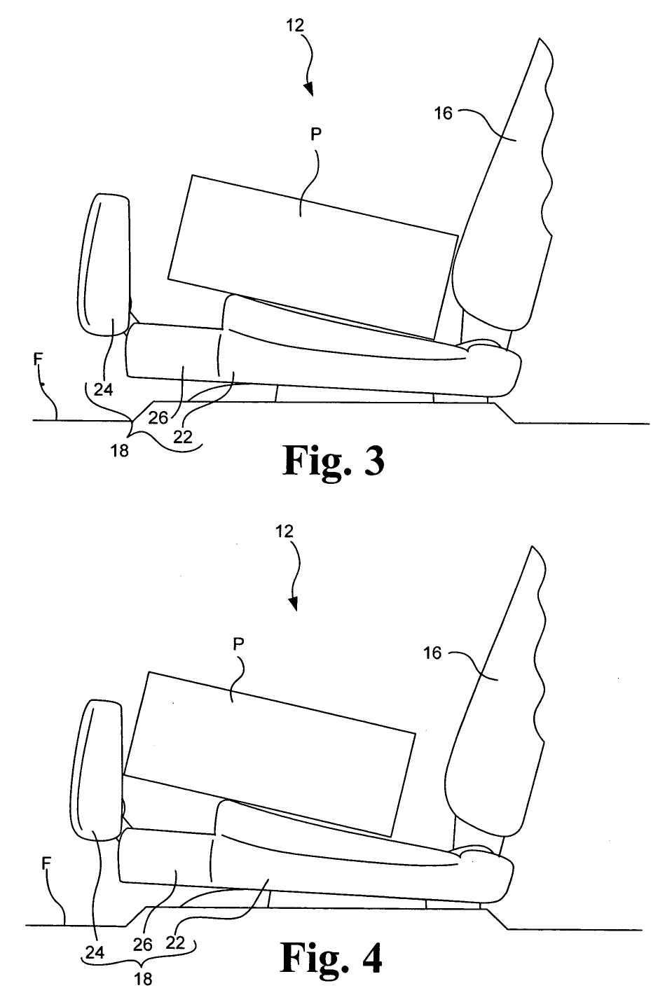

With the front section 24 in the upright cargo retaining orientation, as shown in FIGS. 3 and 4, a confined seat-top space is created between the front section 24 and the seat back portion 16 in order to restrain cargo or luggage against movement as a result of rapid changes in acceleration of the vehicle 10, for instance upon sudden application of the brakes (not shown) within the vehicle 10. For example, when a package P has been placed on the vehicle seat assembly 12, the package P will normally at rest on the rear section 22 of the vehicle seat assembly 12 as seen in FIG. 3. Upon sudden application of vehicle brakes, the package P may shift forward due to momentum as the speed of the vehicle 10 rapidly decreases. However, as shown in FIG. 4, the package P contacts the front section 24, which prevents the package P from sliding forward onto the floor F of the vehicle 10.

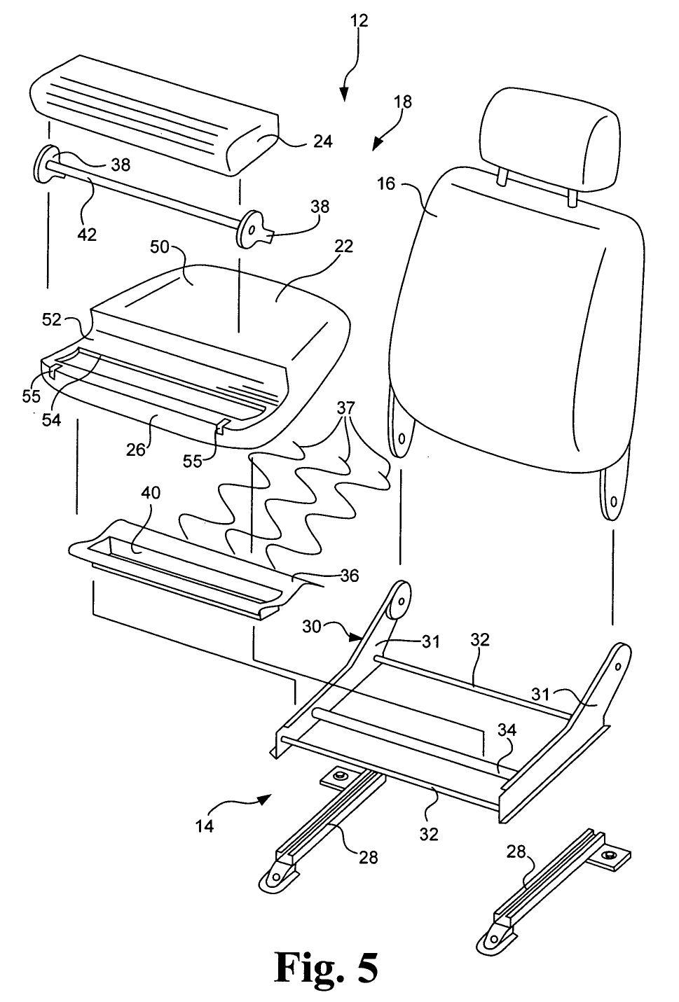

With specific reference to FIG. 5, a more detailed description of the various elements of the vehicle seat assembly 12 is now provided. First, the seat support structure 14 is described. The seat support structure 14 basically includes a pair of floor mounted tracks 28 and a support frame 30. The floor mounted tracks 28 are generally parallel and are fixed to the floor F of the vehicle 10 by fasteners (not shown). The support frame 30 includes a pair of generally parallel side members 31, a pair of support members 32, a laterally extending anti-submarining member or beam 34, a seat pan 36, a plurality of seat support wires 37 and a pair of hinges 38. The side members 31 engage the floor mounted tracks 28 in a conventional manner such that the support frame 30 is adjustably positionable along the length of the floor mounted tracks 28 by a positioning adjustment mechanism (not shown). The support members 32 are spaced apart from one another and extend between the side members 31 of the support frame 30, with one of the support members 32 at the front and one at the rear of the support frame 30.

It should be understood from the drawings and the description herein that the floor mounted tracks 28 are optional and the seat support structure 14 can have a variety of configurations as needed and/or desired. For example, the support frame 30 can be fixed directly to the floor F or other portion of the vehicle 10. Moreover, the vehicle seat assembly 12 can be installed as part of a rear seat in the back of a passenger compartment of the vehicle 10 without a positioning adjustment mechanism and without the floor mounted tracks 28. However, if the vehicle seat assembly 12 is installed in a front area of a passenger compartment of the vehicle 10 adjacent to a driver's seat, the positioning adjustment mechanism and the floor mounted tracks 28 are preferably included.

The anti-submarining member 34 extends between the side members 31 at a location that is rearward of the front section 24 of the seat cushion portion 18. The anti-submarining member 34 is a structural element that helps prevent a passenger's torso and legs sliding into the dashboard (not shown) of the vehicle 10 in the event of a rear or head-on collision. Anti-submarining technology, in general, is well known. Examples of anti-submarining technology can be found in the following patents: U.S. Pat. No. 5,542,747; U.S. Pat. No. 6,648,409; and U.S. Pat. No. 6,746,077.

The seat pan 36 is fixed to the support frame 30 of the seat support structure 14 by fasteners or by welding. Further, the seat pan 36 can be shaped to rest on the forward one of the support members 32 and the anti-submarining member 34. The seat pan 36 can be either made of one or more metal sheets or molded as a hard plastic member. The seat pan 36 includes a recess 40 that defines a storage compartment that is located between the forward one of the support members 32 and the anti-submarining member 34. As described in greater detail below, the recess 40 (the storage compartment) is covered by the front section 24 of the seat cushion portion 18 when the front section 24 is in the passenger supporting orientation and exposed when the front section 24 is in the upright cargo retaining orientation. The seat support wires 37 are connected between the rearward one of the support members 32 and the rear end of the seat pan 36.

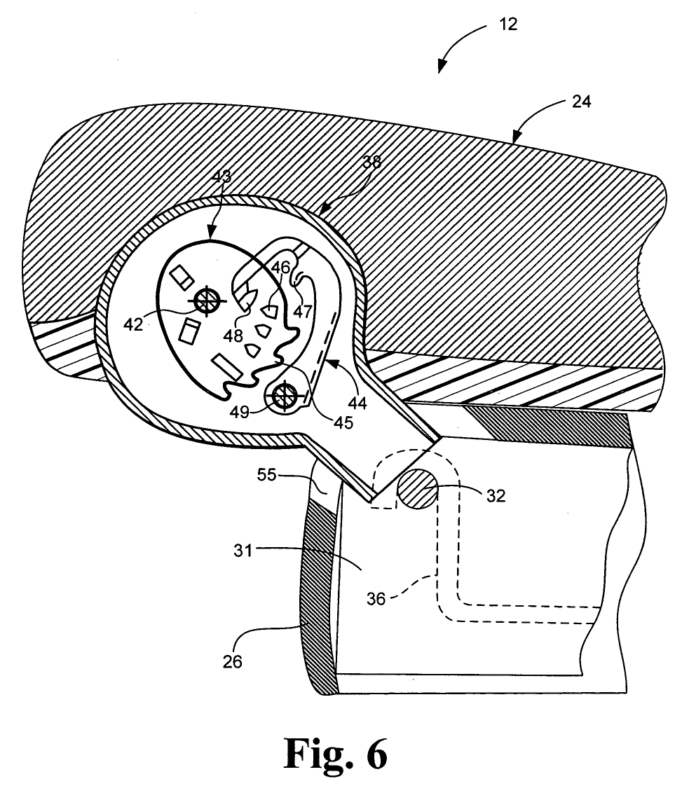

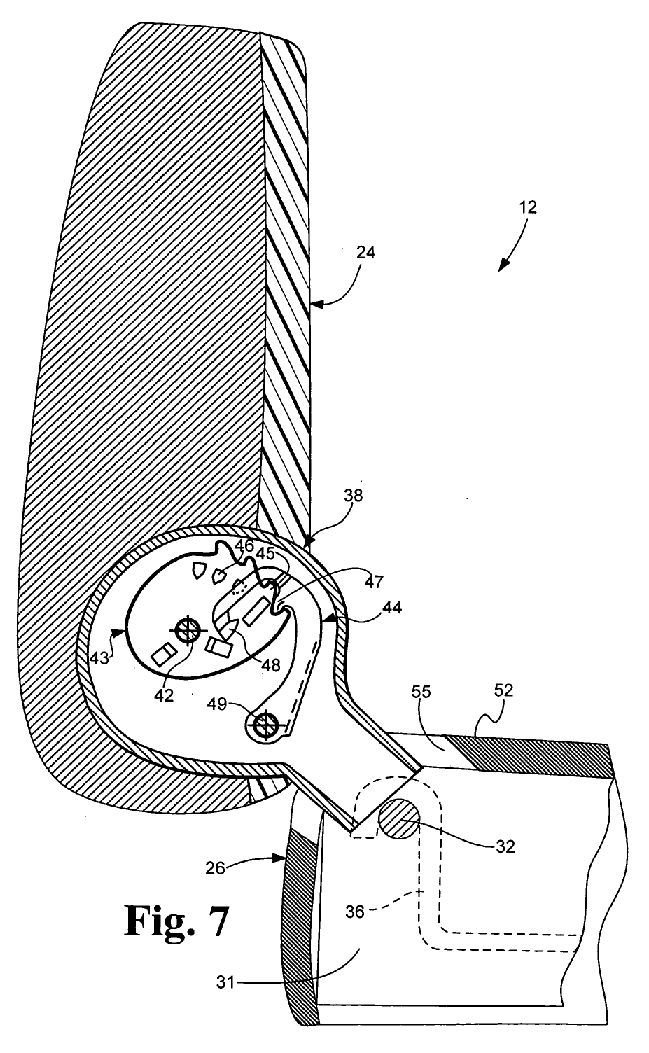

The hinges 38 are conventional hinges that are fixed to forward ends of respective ones of the side members 31 of the support frame 30. The hinges 38 can be bonded, welded or fixed by fasteners (not shown) to the forward end of the side members 31, as shown in FIGS. 6 and 7. Each of the two hinges 38 functions in the same general manner with generally the same structural and functional features. Thus, the description of one of the hinges 38 applies to both. Therefore, description of only one of the hinges 38 is provided for the sake of brevity.

The hinges 38 are configured to support the front section 24 of the seat cushion portion 18. A hinge shaft 42 extends between the two hinges 38 (and the front section 24). The hinge shaft 42 defines a pivot axis about which the front section 24 pivots. The hinge 38 can include a position locking mechanism such as that shown in FIGS. 6 and 7. For instance, the hinge 38 can include a movement arresting plate 43 and a pawl member 44. The movement arresting plate 43 is fixed to the hinge shaft 42 for rotation therewith and includes at least one positioning stop 45 and at least one control projection 46. The pawl member 44 includes at least one movement arresting tooth 47 and a control tooth 48. The pawl member 44 is configured for limited pivoting movement about a pivot pin 49.

When a passenger lifts the front section 24 from the passenger supporting orientation shown in FIG. 6, movement of the front section 24 causes rotation of the hinge shaft 42, which in turn causes rotation of the movement arresting plate 43. As the front section 24 is lifted, the stops 45 on the movement arresting plate 43 engage the movement arresting tooth 47 on the pawl member 44 and the movement arresting tooth 47 and the pawl member 44 engage one another locking the front section 24 in an angled intermediate orientation (not shown). Movement of the front section 24 slightly toward the passenger supporting orientation causes the control tooth 48 to engage one of the control projections 46, thereby causing the pawl member 44 to pivot moving the movement arresting tooth 47 away from the positioning stops 45. The front section 24 can then be pivoted further to yet another angled intermediate orientation (not shown) and eventually to the upright cargo retaining orientation.

It should be understood from the drawings and description herein that the number control projections 46 determines the number of angled intermediate orientations in which the front section 24 can be positioned. Although a plurality of the control projections 46 are depicted, several control projections 46 can be included or just one control projection 46 can be included corresponding to the upright cargo retaining orientation shown in FIG. 7. In other words, the hinges 38 can be configured to lock the front section 24 in the upright cargo retaining position only or can be configured to lock the front section 24 in a plurality of angled intermediate orientations. Operation and use of the hinge 38 is well known in the art and is further described in greater detail in, for example, U.S. Pat. No. 4,354,710, issued Oct. 19, 1982.

Further, it should be understood from the drawings and the description herein that the hinges 38 can include any of a variety of configurations and are not limited to the configuration shown in FIGS. 6 and 7. For example, the hinges 38 can be constructed without a position locking mechanism. Instead, the hinges 38 can include stops (not shown) that limit movement of the front section 24 of the seat cushion portion 18 for movement only between the passenger supporting orientation and the upright cargo retaining orientation. Alternatively, a push button mechanism (not shown) or release lever mechanism (not shown) can be included with the hinges 38 for restricting movement of the front section 24 of the seat cushion portion 18.

The hinge shaft 42 and a majority of the hinges 38 are concealed internally within the front section 24, and hence are not entirely visible in the depicted embodiment. However, it should be understood from the drawings and description herein that the hinges 38 can be partially exposed or entirely exposed depending upon aesthetics and other design considerations.

As shown in FIGS. 5, 8 and 9, the seat back portion 16 is supported on a rear portion of the seat support structure 14 in a conventional manner. Although not shown, the seat back portion 16 can include a reclining mechanism that allows angular adjustment of the seat back portion 16 relative to the seat support structure 14. The non-depicted reclining mechanism can allow the seat back portion 16 to recline from a generally upright orientation (FIGS. 2, 8 and 9) to an inclined orientation (not shown) in a conventional manner. For the sake of brevity, a description of the reclining mechanism of the seat back portion 16 is omitted. Further, it should be understood from the drawings and description that the reclining mechanism is preferably omitted from the vehicle seat assembly 12 when the vehicle seat assembly 12 is installed in the back of the passenger compartment of the vehicle 10. The reclining mechanism is preferably included in the vehicle seat assembly 12 when the vehicle seat assembly 12 is installed in the front of the passenger compartment of the vehicle 10 when serving as the passenger seat of the vehicle 10.

As shown in FIGS. 5, 8 and 9, the rear section 22 of the seat cushion portion 18 is supported by and fixed to the support frame 30 in a conventional manner, for instance by fasteners (not shown) or snap-fit elements. However, it should be understood from the drawing and description herein that the rear section 22 can be molded and/or at least partially integrally formed as a part of the support frame 30 in any of a variety of configurations.

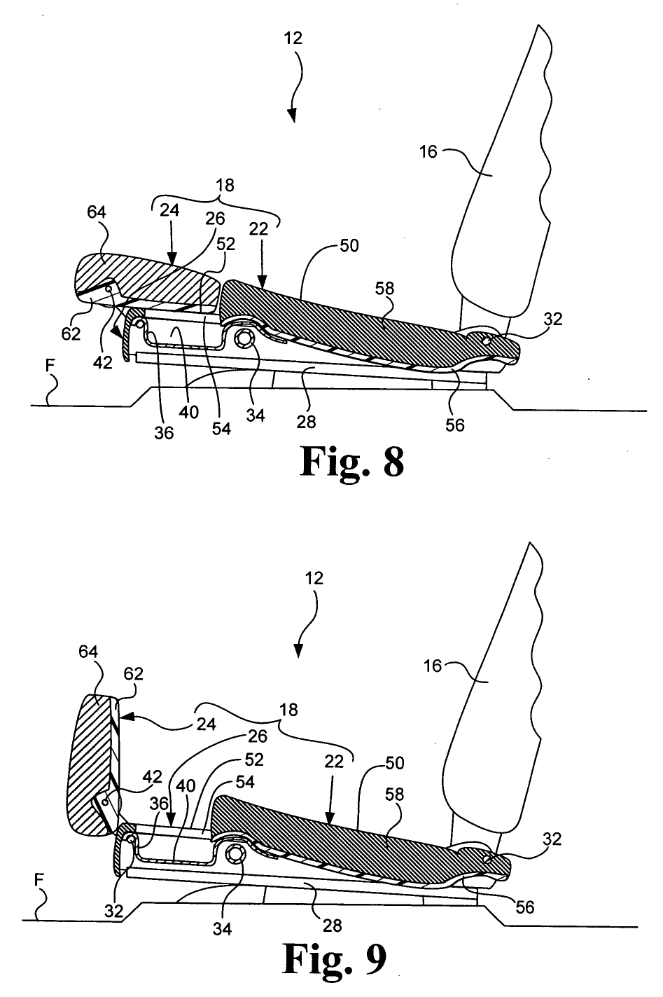

The rear section 22 of the seat cushion portion 18 includes a seating surface 50 that is offset from an upper surface 52 of the front support section 26. The upper surface 52 is preferably configured and arranged to form a cutout portion that is dimensioned and shaped to compliment and receive the front section 24 of the seat cushion portion 18. Specifically, with the front section 24 in the passenger supporting orientation shown in FIGS. 2 and 8, the front section 24 conveniently conforms to the shape of the upper surface 52 of the front support section 26. Further, with the front section 24 in the passenger supporting orientation, the front section 24 and the rear section 22 together provide a smooth comfortable seating surface for a vehicle passenger.

The upper surface 52 of the front support section 26 is provided with an opening 54 and two slots 55 (shown in FIGS. 5-7 only). The opening 54 is dimensioned and positioned to be in alignment with the recess 40 in the seat pan 36. The opening 54 is designed to conform to the shape of the recess 40 further enhancing the appearance and depth of the storage compartment defined by the recess 40 in the seat pan 36.

The slots 55 are positioned forward from the opening 54 and adjacent to the sides of the rear section 22 within the upper surface 52 of the front support section 26. The slots 55 are dimensioned to allow the hinges 38 to extend therethrough, as shown in FIGS. 6 and 7.

The rear section 22 of the seat cushion portion 18 can be formed in any of a variety of ways. For example, the rear section 22 can be a single molded member or as shown in cross-section in FIGS. 8 and 9, can be formed with a molded lower support layer 56 and a seat cushion layer 58. The molded lower support layer 56 is preferably made of a rigid supporting material such as metal or molded plastic. The seat cushion layer 58 is preferably a soft comfort providing material that can further be covered by a textile material (not shown) or a leather material (not shown). The opening 54 is also sized such that the hinges 38 extend through the opening 54. It should be understood from the drawings and the disclosure, that the seat pan 36 and the molded lower support layer 56 can be separate elements as described above, or alternatively can be molded integrally together as a single member with the recess 40 and the opening 54 formed therein.

As shown in FIGS. 5, 8 and 9, the front section 24 basically includes a molded support layer 62 and a cushion layer 64. The front section 24 is supported by the hinges 38 on the support frame 30. Specifically, the hinge shaft 42 extends through a forward section of the molded support layer 62 of the front section 24 as shown in FIGS. 8 and 9. Preferably, the hinge shaft 42 is fixedly attached to the molded support layer 62 such that the movement restricting mechanism of the hinges 38 controls pivotal movement of the front section 24. The front section 24 is pivotal about the pivot axis (with the hinge shaft 42) that extends through a forward portion of the seat support structure 14 forward from the anti-submarining member 34. As can be seen in FIGS. 8 and 9, the front section 24 is pivotal about the pivot axis for movement upward and away from the seat back portion 16 to the upright cargo retaining orientation.

### Second Embodiment

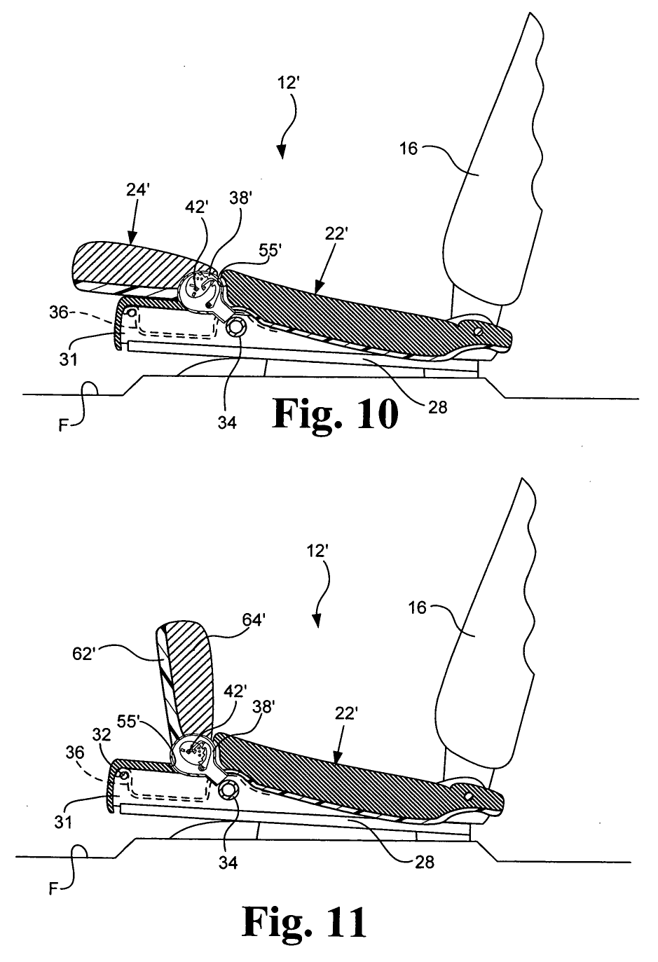

Referring now to FIGS. 10 to 13, a vehicle seat assembly 12′ in accordance with a second embodiment of the present invention will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a prime (′).

As shown in FIGS. 10-13, the vehicle seat assembly 12′ is substantially identical to the vehicle seat assembly 12 of the first embodiment, except that the rear and front sections 22 and 24 of the first embodiment has been replaced with modified rear and front sections 22′ and 24′ and the hinges 38 of the first embodiment have been replaced with modified hinges 38′. The hinges 38′ operate functionally in a manner that is similar to the hinges 38 of the first embodiment, except that the hinges 38′ have been reconfigured to allow the front section 24′ to move upwardly and rearwardly toward the seat back 16.

The hinges 38′ are attached to the side members 31 at a location that is slightly forward from the anti-submarining member 34 (rearward from the location of the hinges 38 in the first embodiment). The hinges 38′ can be welded or attached by fasteners (not shown) to the side members 31.

A hinge shaft 42′ extends between the hinges 38′ in a manner similar to the first embodiment. The hinge shaft 42′ extends through the front section 24′. However, in the second embodiment, the front section 24′ is pivotal about the pivot axis (the hinge shaft 42′) for movement upward and toward the seat back portion 16. More specifically, the pivot axis (the hinge shaft 42′) extends through a rearward portion of the front section 24′. The slots 55 are positioned forward from the opening 54 and adjacent to the sides of the rear section 22 within the upper surface 52 of the front support section 26. Slots 55′ are dimensioned to allow the hinges 38′ to extend therethrough, as shown in FIGS. 10 and 11. The slots 55′ are similar to the slots 55 in the first embodiment, except that the slots 55′ are located slightly forward from the anti-submarining member 34 proximate the sides of the front section 22′.

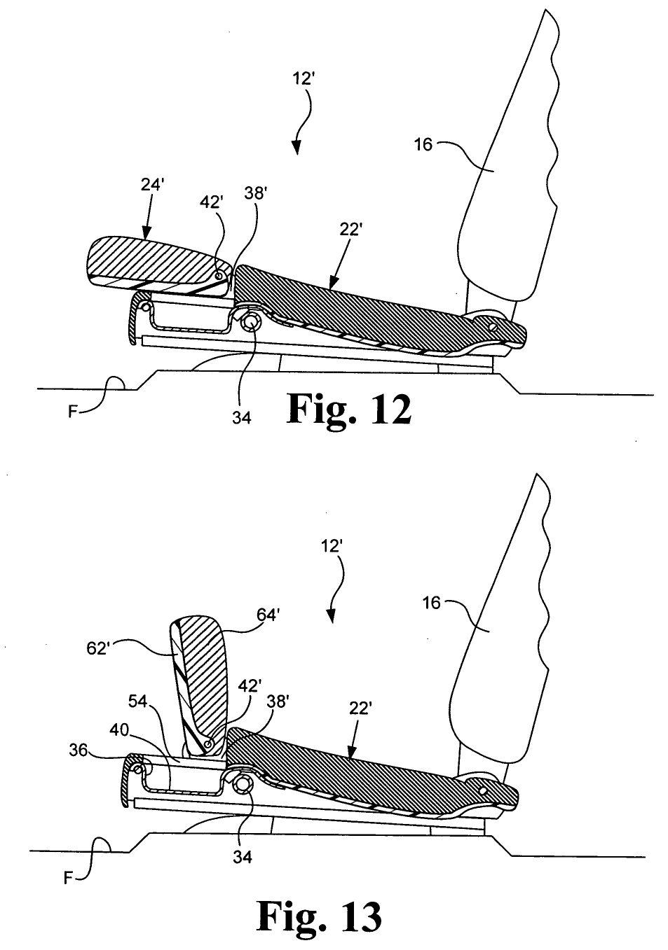

As shown in FIGS. 12 and 13, the front section 24′ of the second embodiment includes a molded support layer 62′ and a cushion layer 64′. The hinge shaft 42′ extends through a rearward portion of the molded support layer 62′. The hinge shaft 42′ is fixedly attached to the molded support layer 62′ such that the hinge shaft 42′ and the front section 24′ pivot together as one.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

As used herein to describe the present invention, the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention as used in the normal operating conditions. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A vehicle seat assembly comprising:
a seat support structure;
a seat back portion coupled to the seat support structure; and
a seat cushion portion coupled to the seat support structure, the seat cushion portion including a rear section and a front section, wherein the front section is movably mounted to the seat support structure for operation in a passenger supporting orientation and an upright cargo retaining orientation.

2. The vehicle seat assembly as set forth in claim 1, wherein
the front section is pivotal about a pivot axis that extends through a forward portion of the seat support structure.

3. The vehicle seat assembly as set forth in claim 2, wherein
the front section is pivotal about the pivot axis for movement upward and away from the seat back portion.

4. The vehicle seat assembly as set forth in claim 2, wherein
the front section is pivotal about the pivot axis for movement upward and toward the seat back portion.

5. The vehicle seat assembly as set forth in claim 1, wherein
the seat support structure includes a storage compartment that is covered by the front section when the front section is in the passenger supporting orientation and exposed when the front section is in the upright cargo retaining orientation.

6. The vehicle seat assembly as set forth in claim 1, wherein
the seat support structure includes a pan formed with a recess defining a storage compartment that is covered by the front section when the front section is in the passenger supporting orientation and exposed when the front section is in the upright cargo retaining orientation.

7. The vehicle seat assembly as set forth in claim 1, wherein
the seat support structure includes a laterally extending anti-submarining member located rearward of the front section of the seat cushion portion.

8. The vehicle seat assembly as set forth in claim 7, wherein
the front section is pivotal about a pivot axis that extends through a forward portion of the seat support structure forward from the anti-submarining member.

9. The vehicle seat assembly as set forth in claim 8, wherein
the front section is pivotal about the pivot axis for movement upward and away from the seat back portion.

10. The vehicle seat assembly as set forth in claim 8, wherein
the front section is pivotal about the pivot axis for movement upward and toward the seat back portion.

11. The vehicle seat assembly as set forth in claim 8, wherein
the seat support structure includes a storage compartment that is covered by the front section when the front section is in the passenger supporting orientation and exposed when the front section is in the upright cargo retaining orientation.

12. The vehicle seat assembly as set forth in claim 7, wherein
the seat support structure includes a pan formed with a recess located forward from the anti-submarining member that defines a storage compartment covered by the front section when the front section is in the passenger supporting orientation and exposed when the front section is in the upright cargo retaining orientation.

13. The vehicle seat assembly as set forth in claim 1, wherein
the seat support structure includes two generally parallel side members configured to support the seat back portion and the seat cushion portion.

14. The vehicle seat assembly as set forth in claim 13, wherein
the seat support structure includes a storage compartment that is covered by the front section when the front section is in the passenger supporting orientation and exposed when the front section is in the upright cargo retaining orientation, the storage compartment extending between the two generally parallel side members.

15. The vehicle seat assembly as set forth in claim 13, wherein
the seat support structure includes a laterally extending anti-submarining member located rearward of the front section of the seat cushion portion and extending between the two generally parallel side members.

16. The vehicle seat assembly as set forth in claim 13, wherein
the front section is pivotal about a pivot axis that extends between forward portions of the two generally parallel side members.

17. The vehicle seat assembly as set forth in claim 16, wherein
the front section is pivotal about the pivot axis for movement upward and away from the seat back portion.

18. The vehicle seat assembly as set forth in claim 16, wherein
the front section is pivotal about the pivot axis for movement upward and toward the seat back portion.

19. The vehicle seat assembly as set forth in claim 13, wherein
the seat support structure includes a pan disposed between the two generally parallel side members, the pan being formed with a recess defining a storage compartment that is covered by the front section when the front section is in the passenger supporting orientation and exposed when the front section is in the upright cargo retaining orientation.
